(19) United States
(12) Patent Application Publication
(10) Pub. No.: US 2025/0203239 A1
(43) Pub. Date: Jun. 19, 2025

(54) SYSTEMS AND METHODS FOR HIGH DYNAMIC RANGE IMAGING SENSING

(71) Applicant: Adeia Imaging LLC, San Jose, CA (US)

(72) Inventors: Ning Xu, Irvine, CA (US); Tao Chen, Palo Alto, CA (US)

(21) Appl. No.: 18/541,564

(22) Filed: Dec. 15, 2023

(51) Int. Cl. H04N 25/706; G06T 7/20; H04N 23/73; H04N 23/74; H04N 25/57

(52) U.S. Cl. CPC H04N 25/706; G06T 7/20; H04N 23/73; H04N 23/74; H04N 25/57; G06T 2207/10144

(57) ABSTRACT

One or more of the described systems, methods, and apparatuses relate to imaging devices with integrated light exposure control. An imaging device comprises an image sensor and a light modulation layer coupled to the image sensor. The light modulation layer comprises a plurality of liquid-crystal (LC) device pixels over the image sensor. The imaging device comprises control circuitry coupled to the image sensor and the light modulation layer. The control circuitry is configured to apply a transparency mask to the light modulation layer by modifying, based on at least one frame captured at the image sensor, pixel attributes of the plurality of LCD pixels for modulating exposure of the image sensor.

### BACKGROUND

The present disclosure relates to systems and methods for imaging devices with integrated light exposure control. One or more of the systems and methods described herein provide for a high dynamic range (HDR) imaging device having integrated dynamic light modulation at pixel level.

### SUMMARY

Demand for imaging systems capable of capturing scenes with high dynamic range has motivated advances in HDR imaging. Simultaneous capture of bright and dark areas can result in, for example, overexposed bright regions and underexposed darker regions within the same frame, which limits details in the image captured. In some approaches using bracketing, multiple images are successively captured, ranging from underexposed to overexposed. The images are merged using image processing to develop a single HDR composite image having an average exposure around a mid-tone luminance of a scene. Although these approaches may retain image details from the brightest and darkest regions, the extended capture time can result in artifacts such as motion artifacts due to moving objects between images (e.g., blurring), shaking of the camera, and other factors. Further, the extended capture and processing time may render these approaches unsuitable for videography and other imaging applications.

Some approaches involve redesigning the sensor hardware, which may increase manufacturing complexity. For example, in one approach, a beam splitter is used to separate the amount of incident light reaching multiple different image sensors. In another approach, one or more pixels of an image sensor may be organized as subpixel regions, where each subpixel has adjustable exposure time. Such approaches may increase complexity for building the optical system and may reduce the capable spatial resolution. Further, artifacts may be introduced to different parts of an object, such as a different amount of motion blur to parts of the same moving object captured by different subpixel regions.

To help address the aforementioned limitations and other unsatisfactory aspects, systems and methods are described herein for an imaging device with integrated light modulation by modulating the amount of light entering each pixel within a range of exposure time (e.g., with about the same amount of exposure time). One or more of the described embodiments herein may be combined with other approaches or parts thereof (e.g., beam splitting, subpixels, and/or HDR processing techniques) to further extend the dynamic range. It is noted that exposure levels may be adjusted based on various criteria (e.g., scene luminance, dynamic range, signal-to-noise ratio, scene tone, ambient light, etc.).

In some embodiments, the imaging device comprises an image sensor, a light modulation layer coupled to the image sensor, and control circuitry coupled to the image sensor and the light modulation layer. For example, the image sensor and the light modulation layer may have one or more intervening layers disposed therebetween. For example, the light modulation layer may be attached to the image sensor. For example, the light modulation layer may be directly bonded to the image sensor. For example, the light modulation layer may be optically coupled to the image sensor. For example, the light modulation layer may be connected to the image sensor through one or more conductive lines, pads, etc. Some example connections include through-substrate vias (TSVs), through-dielectric vias, wiring, interconnects, conductive posts, etc. The light modulation layer comprises liquid-crystal (LC) device pixels (e.g., in an array, a grid, or another layout) that are disposed over the image sensor. For example, the LC device pixels may be disposed directly over sensor pixels of the image sensor. For example, the LC device pixels are positioned such that incident light passes through one or more LC device pixels to reach the image sensor (e.g., a photo-diode or other light-sensitive element of the image sensor). The control circuitry is configured to modify attributes of the LC device pixels based on feedback of the image sensor (e.g., based on at least one frame captured by the image sensor). For example, as scenes are captured via the image sensor, the control circuitry adjusts the transparency of one or more LC device pixels to manage exposure of each image sensor pixel. In some embodiments, the control circuitry, using the LC device pixels, is configured to manage the exposure for one or more regions of image sensor pixels.

In some embodiments, the imaging device comprises a CMOS sensor, or other active-pixel sensor, and an LC device layer directly bonded to the CMOS sensor. The LC device layer comprises a plurality of pixels for modulating exposure of the CMOS sensor. For example, the LC device layer may comprise an image processor that adjusts transparency of the LC pixels. For example, the LC device layer may comprise circuitry configured to control voltages of a plurality of LC pixels to control the polarization. For example, the CMOS sensor may comprise processing circuitry configured to analyze one or more captured frames and to transmit one or more instructions for adjusting voltages of the plurality of LC pixels to modulate exposure of the CMOS sensor.

In some embodiments, modulating exposure of an imaging device comprises capturing sensor data for at least one frame and identifying overexposed regions and/or underexposed regions based on the sensor data. In some embodiments, light intensity of a region is determined to exceed a threshold (e.g., exceed a detectable pixel value range of a CMOS sensor pixel). In response to identifying these regions, a transparency mask is computed that adjusts the exposure for these regions. The transparency mask may be applied to a light modulation layer with an LC pixel array by modifying attributes of each LC pixel that is positioned over the overexposed and/or underexposed regions.

An imaging device may comprise an LC device layer directly bonded to a CMOS sensor. The LC device layer comprises a plurality of LC device pixels. In some embodiments, modulating exposure of the imaging device comprises capturing a first frame, computing exposure of the CMOS sensor based on the first frame. Light intensity may be determined to meet or exceed a threshold at one or more portions of the CMOS sensor. In response to determining that the threshold is met or exceeded, modulating the exposure comprises determining a transparency mask to modulate exposure of the one or more portions by computing respective voltages for one or more LC device pixels of the LC device layer corresponding to the one or more portions and applying the transparency mask to the corresponding LC device pixels of the LC device layer.

In some embodiments, capturing the sensor data comprises capturing one or more first frames with a first exposure time different than other second frames using a second exposure time (e.g., a target exposure time based on imaging device settings). The exposure value may be computed partly based on the exposure time. For example, the first frame used for analyzing exposure levels (e.g., to identify overexposure and/or underexposure) can be captured by using a shorter exposure time. In this example, the exposure analysis may be performed faster than using the target exposure time. As a non-limiting example, the exposure time for the first frame may be a fraction (e.g., 1/50, 1/30, 1/10, etc.) of the target exposure time for a second frame. Analyzing the first frame may identify an overexposed and/or underexposed region (e.g., within a range of around 1000% overexposure or underexposure). The control circuitry may compute a higher or lower transparency level (e.g., within a range of about 5%, 10%, 50%, 90%, etc.) that adjusts the overexposure or underexposure to an exposure value of the region within an exposure range. The exposure value may be computed based on the target exposure time for the second frame.

As an illustrative example, the control circuitry may use image processing techniques to compute the exposure from the sensor data, determine which regions have disparate brightness levels, and identify LC pixels corresponding to the regions. For an overexposed region, the control circuitry may compute a decrease to the transparency level of the corresponding LC pixel(s) such that the exposure is reduced. In an analogous manner for an underexposed region, the control circuitry may compute an increase to the transparency level of the corresponding LC pixel(s) such that the exposure is increased. The control circuitry determines a transparency mask by computing the adjustments to the transparency levels for corresponding LC pixels. The control circuitry may modify the transparency levels of the LC pixels, for example, by applying voltage levels to the LC pixels that modify the polarizations of the liquid crystal components. In this manner, exposure for the imaging device may be modulated using an LC layer.

In some embodiments, the control circuitry may increase the transparency level corresponding to one or more regions if the pixels for the one or more regions would not exceed an acceptable exposure range (e.g., not overexposed or within the exposure range of the sensor pixel). For example, the one or more regions may currently have an exposure level that falls within the acceptable exposure range (e.g., not underexposed or overexposed). The control circuitry may compute an expected exposure level if the transparency level is increased and determine, based on the sensor data, that the expected exposure level is within an acceptable exposure range corresponding to the one or more regions. In response to determining that the expected exposure level is within the acceptable exposure range, the control circuitry may increase the transparency level of LC pixels corresponding to the one or more regions.

In some embodiments, the control circuitry computes a predicted motion field based on sensor data corresponding to one or more previous frames and determines a predicted transparency mask for a subsequent frame. As an illustrative example, the control circuitry may receive sensor data corresponding to a first frame captured at time t. The image sensor may have captured the first frame after having a first transparency mask applied at the LC pixels such that the sensor data includes the masked sensor pixel values. The control circuitry analyzes the sensor data and determines a second transparency mask for a second frame corresponding to time t+1. The control circuitry may retrieve the first transparency mask (e.g., from memory). The control circuitry reconstructs the sensor data corresponding to the first frame without the first transparency mask. For example, an unmasked sensor pixel value may be computed as the masked sensor value divided by the transparency of a corresponding LC pixel. The control circuitry may retrieve and reconstruct sensor data for one or more previous frames (e.g., corresponding to times t−1, t−2, etc.). The control circuitry, using a motion prediction model, determines the predicted motion field based on the frames t, t−1, etc. For example, sensor data correspond to the frames t, t−1, etc. may have been stored in memory. The control circuitry may determine the predicted motion field based on the sensor data corresponding to the stored frames. The predicted motion field may indicate a light source moves between times t and t+1 such that one or more sensor pixels are expected to have high exposure at the upcoming frame (e.g., time t+1). The control circuitry may determine the predicted transparency mask to adjust exposure levels of the expected sensor pixels.

In some embodiments, the imaging device may comprise an image sensor, an LC device coupled to the image sensor, and one or more lenses disposed over the LC device and the image sensor. For example, the image sensor and the LC device may be optically coupled. For example, the image sensor and the LC device may be attached (e.g., directly bonded). For example, the image sensor and the LC device may have one or more intervening layers disposed therebetween. As an example, the lens may focus incident light towards at least one LC pixel of the LC device. The LC device pixel may comprise a first polarizer positioned proximate to the lens. For example, the first polarizer may be coupled (e.g., attached) to the lens. In some embodiments, the first polarizer is positioned at a focal point of the lens such that the incident light is polarized by the first polarizer. Beneficially, this arrangement would have one less layer between the LC device pixel and an image sensor pixel, thereby reducing a thickness of a stack including the LC device pixel and image sensor pixel.

The LC device pixel may comprise a second polarizer and an LC layer. The second polarizer may be coupled (e.g., attached) to the image sensor. For example, the second polarizer may be optically coupled to the image sensor through direct bonds therebetween. In some advantageous aspects, the first polarizer may be adjusted for incident light from different directions, for example, during operation of the imaging device while capturing an image. For example, the first polarizer may have a first angle to receive light from a first direction. The first angle may be measured relative to the lateral plane of the LC device pixel. The second polarizer may have a second angle different from the first angle. The second angle may be about the same as the lateral plane. In some embodiments, settings corresponding to a transparency level of an LC device pixel (e.g., an applied voltage) are determined based on the angular difference of the first polarizer and the second polarizer.

In some advantageous aspects of the systems and methods described in the present disclosure, the imaging device integrates a dynamic LC layer disposed directly over an image sensor, enabling electronic and precise control of exposure at the pixel level. As scenes are captured, each pixel of the LC layer dynamically adjusts transparencies based on near real-time analysis for controlling the light exposure of the image sensor at the pixel, or subpixel, scale. Beneficially, the imaging device including motion prediction mitigates overexposure and/or underexposure in dynamic scenes having high dynamic range, enabling detailed image capture of both bright and dark regions with about the same exposure time. One or more of the described systems and methods may enable near real-time adjustments to achieve high dynamic range, reducing artifacts and improving image capture of dynamic scenes in videography and other imaging applications as compared to other approaches (e.g., bracketing, post-processing, redesigned sensors, etc.).

### BRIEF DESCRIPTION OF THE DRAWINGS

The present disclosure, in accordance with one or more various embodiments, is described in detail with reference to the following figures. The drawings are provided for purposes of illustration and merely depict some example embodiments. These drawings are provided to facilitate an understanding of the concepts disclosed herein and should not be considered limiting of the breadth, scope, or applicability of these concepts. It should be noted that for clarity and ease of illustration, these drawings may not be made to scale.

FIG. 1 shows an illustrative example of an imaging device having integrated exposure control, in accordance with some embodiments of this disclosure;

FIG. 2 shows an illustrative flow diagram for integrated exposure control of an imaging device, in accordance with some embodiments of this disclosure;

FIG. 3 shows an illustrative scenario of HDR imaging using integrated exposure control, in accordance with some embodiments of this disclosure;

FIG. 4 shows illustrative structures having a light modulator attached to an image sensor, in accordance with some embodiments of this disclosure;

FIG. 5 shows example bonded structures of LC device dies attached to CMOS sensor dies, in accordance with some embodiments of this disclosure;

FIG. 6 is a flowchart of a detailed illustrative process for integrated exposure control, in accordance with some embodiments of this disclosure;

FIG. 7 is a flowchart of a detailed illustrative process for image processing including integrated exposure control, in accordance with some embodiments of this disclosure;

FIG. 8 is a flowchart of a detailed illustrative process for image processing of dynamic scenes including integrated exposure control, in accordance with some embodiments of this disclosure; and

FIG. 9 shows an illustrative block diagram of a device system, in accordance with embodiments of the disclosure.

### DETAILED DESCRIPTION

As described herein, the term “substrate” means and includes any workpiece, wafer, or article that provides a base material or supporting surface from which or upon which components, elements, devices, assemblies, modules, systems, or features of the heat-generating devices, packaging components, and cooling assembly components described herein may be formed. The term substrate also includes “semiconductor substrates” that provide a supporting material upon which elements of a semiconductor device are fabricated or attached, and any material layers, features, and/or electronic devices formed thereon, therein, or therethrough. For example, a substrate may comprise a rigid material such as crystalline or polycrystalline silicon.

As described herein, a semiconductor substrate has a “device side,” e.g., the side on which semiconductor device elements are fabricated, such as transistors, resistors, and capacitors, and a “backside” that is opposite the device side. The term “active side” should be understood to include a surface of the device side of the substrate and may include the device side surface of the semiconductor substrate and/or a surface of any material layer, device element, or feature formed thereon or extending outwardly therefrom, and/or any openings formed therein. Thus, it should be understood that the material(s) that form the active side may change depending on the stage of device fabrication and assembly. Similarly, the term “non-active side” (opposite the active side) includes the non-active side of the substrate at any stage of device fabrication, including the surfaces of any material layer, any feature formed thereon, or extending outwardly therefrom, and/or any openings formed therein. Thus, the terms “active side” or “non-active side” may include the respective surfaces of the semiconductor substrate at the beginning of device fabrication and any surfaces formed during material removal, e.g., after substrate thinning operations. Depending on the stage of device fabrication or assembly, the terms “active” and “non-active sides” are also used to describe surfaces of material layers or features formed on, in, or through the semiconductor substrate, whether or not the material layers or features are present in the fabricated or assembled device.

Spatially relative terms are used herein to describe the relationships between elements, such as the relationships between substrates, heat-generating devices, cooling assembly components, device packaging components, and other features described below. Unless the relationship is otherwise defined, terms such as “above,” “over,” “upper,” “upwardly,” “outwardly,” “on,” “below,” “under,” “beneath,” “lower,” and the like are generally made with reference to the X, Y, and Z directions set forth in the drawings. Thus, it should be understood that the spatially relative terms used herein are intended to encompass different orientations of the substrate and, unless otherwise noted, are not limited by the direction of gravity. Unless the relationship is otherwise defined, terms describing the relationships between elements such as “disposed on,” “embedded in,” “coupled to,” “connected by,” “attached to,” “bonded to,” “proximate to,” either alone or in combination with a spatially relevant term include both relationships with intervening elements and direct relationships where there are no intervening elements. The term “at the” generally denotes an element that is disposed on, embedded in, coupled to, connected by, attached to, bonded to, or proximate to another element.

As described herein, “direct bonding,” or “directly bonded,” refers to two or more elements bonded to one another without an intervening adhesive. In some embodiments, direct bonding can involve the bonding of a single material on the first of the two or more elements and a single material on a second one of the two more elements, where the single materials on the different elements may or may not be the same. Direct bonding can also involve bonding of multiple materials on one element to multiple materials on the other element (e.g., hybrid bonding). As used herein, the term “dielectric bonding” refers to a species of direct bonding in which nonconductive features directly bond to nonconductive features. As used herein, the term “hybrid bonding” refers to a species of direct bonding in which both i) nonconductive features directly bond to nonconductive features, and ii) conductive features directly bond to conductive features.

As described herein, the term “exposure” and variants thereof refer to the amount of light per unit area reaching a photosensitive region of an image sensor. An image or parts thereof may be considered overexposed when there is loss of highlight detail due to overly bright regions. In an analogous manner, an image or parts thereof may be considered underexposed when there is loss of shadow detail due to overly dark regions.

As described herein, the term “light modulation unit” and variants thereof refer to an optical device component having a controllable element that is used to modulate one or more properties of incident light. The properties of the incident light may be within any range that can be suitably captured by an image sensor for imaging applications including the visible spectrum and/or infrared. Some example properties include phase, frequency, amplitude, polarization, etc. It is noted that there are many methods for light modulation, for example, using plasma dispersion, semiconductor absorption, Pockels modulation, quantum-confined Stark effect (QCSE) modulation, etc. Although liquid crystal devices are described herein for illustrative purposes, any light modulation device in an active-matrix configuration or other scheme for controlling attributes of individual pixels may be used for modulating exposure levels of one or more image sensor pixels. Some examples of suitable modulation devices include in-plane switching (IPS) devices, super-IPS, thin-film-transistor (TFT) devices, vertical-alignment (VA) devices, blue-phase-modes, ferroelectrics, Pockels cells, etc. This list is non-exhaustive and is intended to be illustrative and non-limiting.

In some general aspects, a pixel of an LC device comprises a layer of molecules (i.e., liquid-crystal layer) disposed between two transparent electrodes (e.g., comprising indium tin oxide (ITO)), and two polarizing filters (e.g., parallel and perpendicular polarizers). It is noted that the liquid crystal layer may have any chemical composition selected, for example, based on the expected temperatures, pressures, and other operating conditions of the LC device. Some example compositions comprise liquid crystal polymers, mesogens, polarizable benzene rings, phenyl compounds, eutectic phenyl mixtures, etc. For illustrative purposes, the polarizing filters are described having perpendicular axes of transmission to each other, but it is noted that the polarizing filters may have any transmission axis orientation relative to each other without departing from the teachings of the present disclosure.

As described herein, the term “transparency mask” refers to a configuration of settings that correspond to transparency levels of one or more light modulation units, including components thereof (e.g., LC device pixels, liquid crystal layer), and methods for configuring the transparency levels of a light modulation unit. A transparency level indicates how much light may pass through, for example, an LC device pixel. For example, a transparency mask may refer to a voltage configuration. In the context of an LC device pixel, the liquid crystal orientation is changed by the applied voltage, which controls the amount of light passing through the pixel. It is noted that each LC device pixel may have a different applied voltage in an LC device. For example, a transparency mask may refer to an electric field configuration such as when applied to a semiconductor cell, changing the optical absorption. It is contemplated that a transparency mask is agnostic as to which method for configuring the transparency levels is employed.

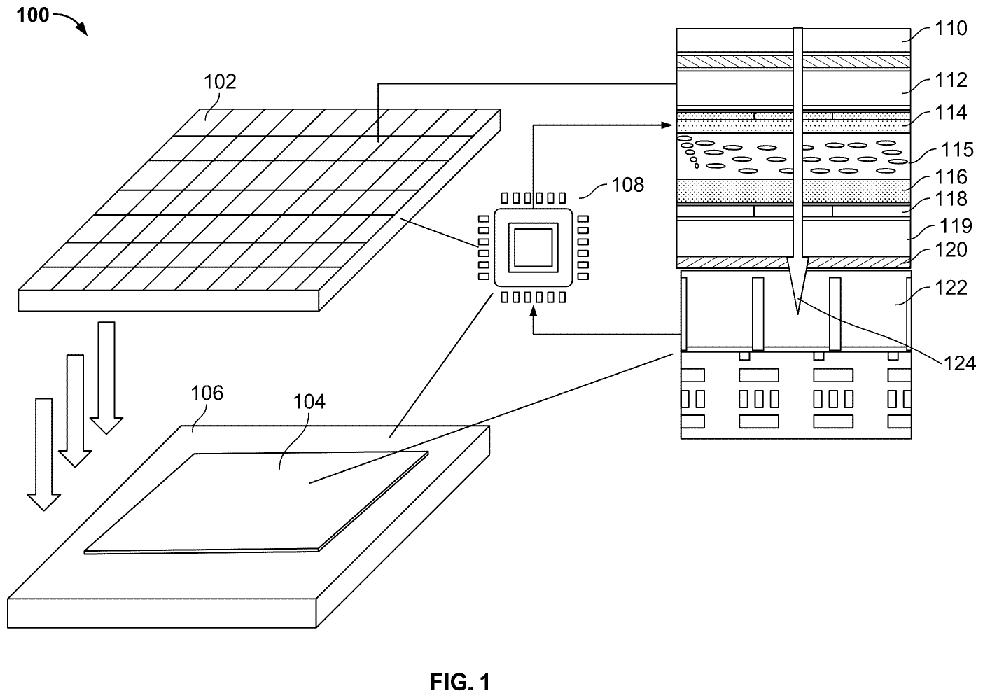

FIG. 1 shows an illustrative example of an imaging device 100 having integrated exposure control, in accordance with some embodiments of this disclosure. The device 100 comprises a light modulation layer, such as an LC device panel 102, disposed over an image sensor 106 having a photosensitive region such as a sensor pixel array 104. The LC device panel 102 may occupy a different lateral area than the sensor pixel array 104. In some embodiments, the LC device panel 102 has about the same dimensions as the sensor pixel array 104. For example, the LC device panel 102 may have about the same lateral area as the sensor pixel array 104. The LC device panel 102 and the image sensor 106 are coupled to a control circuit device 108. The device 108 may comprise integrated circuitry (IC) disposed at the layer 102 and/or the sensor 106. In some embodiments, the device 108 may comprise circuitry disposed partially at the layer 102 and partially at the sensor 106, where the circuitry is interconnected through direct bonds formed between the layer 102 and the sensor 106.

The LC device panel 102 comprises a plurality of LC device pixels having components 110-120. In one embodiment, an LC device pixel comprises a first polarizer 110, a first substrate 112, a first electrode 114, a LC layer 115, a second electrode 116, a second substrate 119, and a second polarizer 120. As an example, the first electrode 114 may be a pixel electrode comprising a thin film transistor. Some example materials of the thin film transistor include amorphous silicon or polycrystalline silicon.

The substrates 112, 119 are optically transparent to incident light 124. For example, the substrates 112, 119 may comprise glass, transparent metal oxide, ITO, carbon nanotube film, transparent polymers, or combinations thereof. In some embodiments, an LC device pixel comprises a color filter 118 (e.g., an RGB filter, a Bayer filter). The image sensor 106 may not have a color filter. The color filter 118 may substitute for a color filtering function in the image sensor 106. For example, the control circuit device 108 may provide color information from the color filter 118 to the image sensor 106. In some embodiments, the image sensor 106 may comprise a color filter, and the color filter 118 supplements the image sensor 106. In some embodiments, a color filter (e.g., color filter 118) comprises a plurality of photodetectors (e.g., three photodiodes) stacked on each other (e.g., using planar fabrication techniques). For example, each photodiode may comprise a respective CMOS cell (e.g., 3T). Each photodiode layer of the stack filters incident light for a successive layer by shifting the spectrum of absorbed light. The control circuit device 108 may reconstruct red, green, and blue signals by deconvolving the response of each layer. In some embodiments, an LC device pixel does not have a color filter.

In some embodiments, an LC device pixel may be rectangular or square, for example, as viewed from above. Some example pixel shapes include elliptical, circular, hexagonal, polygonal, etc. The LC device panel 102 may comprise a plurality of LC device pixels having microscale or smaller pixel size. As an illustrative example, an LC device pixel may have dimensions between about 1 mm or less and about 0.1 μm or greater. For example, an LC device pixel may have a pixel size less than 1 mm, such as about 0.5 mm or less, about 100 μm or less, about 10 μm or less, about 0.5 μm or less, or about 0.1 μm or less (e.g., about 0.9 μm or less).

In some embodiments, the image sensor 106 comprises a plurality of sensor pixels, for example, arranged as sensor pixel array 104. A sensor pixel 122 comprises wiring and one or more photodiodes. In some embodiments, the photodiode may be disposed at a reconstituted substrate. A sensor pixel may have a range of pixel sizes and shapes depending on the imaging applications. In some embodiments, a sensor pixel may be rectangular or square, for example, as viewed from above. Some example pixel shapes include elliptical, hexagonal, polygonal, etc. As an illustrative example, a sensor pixel may have dimensions between about 0.1 mm or less and about 0.01 μm or greater. For example, a sensor pixel may have a pixel size less than 0.1 mm, such as about 0.9 mm or less, about 90 μm or less, about 10 μm or less, about 0.1 μm or less, or about 0.01 μm or less (e.g., about 0.008 μm or less).

In some embodiments, one or more sensor pixels of the sensor pixel array 104 may have a different pixel size (e.g., larger lateral dimensions) than other sensor pixels. A first sensor pixel may have a different exposure level than a second sensor pixel. An exposure level exceeding an exposure range of a sensor pixel may be clipped. In some embodiments, the first sensor pixel may have a different exposure range than the second sensor pixel. As an illustrative example, a first sensor pixel may have an exposure range of [0,1], and the second sensor pixel may have an exposure range of [0,0.8]. If both sensor pixels have light exposure corresponding to about 0.85, the first photodiode may output an exposure level of 0.85, and the second photodiode may output an exposure level clipped to 0.8. The sensor pixel array 104 may have a plurality of sensor pixels configured as a pixel group that outputs a single exposure level. In some embodiments, the control circuit device 108 may determine a highest exposure level from a plurality of sensor pixels (e.g., a pixel group). For example, a pixel group may have sensor pixels with respective exposure levels ranging from about 0.01 to about 0.77, and the control circuitry device 108 determines the exposure level of the pixel group to be about 0.77. The control circuit device 108 may modify pixel attributes of a LC device pixel corresponding the sensor pixel(s) based on the determined exposure level (e.g., the highest exposure level).

In some embodiments, one or more sensor pixels of the sensor pixel array 104 may comprise a plurality of subpixels. For example, a sensor pixel may comprise a first photodiode and a second photodiode. The first photodiode may have a different size (e.g., larger lateral dimensions) than the second photodiode. The first photodiode may receive a different amount of light exposure than the second photodiode. An LC device pixel may modulate the light entering the sensor at subpixel scales. In some embodiments, a sensor pixel is modulated by a plurality of LC device pixels. For example, exposure of at least one sensor pixel may be modulated by two or more LC device pixels.

In some embodiments, the first photodiode may have a different exposure range than the second photodiode. An exposure level exceeding the exposure range of a respective photodiode may be clipped. As an illustrative example, the first photodiode may have an exposure range of [0,1], and the second photodiode may have an exposure range of [0,0.4]. If both photodiodes have light exposure of about 0.5 units, the first photodiode may output an exposure level of 0.5, and the second photodiode may output an exposure level clipped to 0.4. In some embodiments, the control circuit device 108 may determine that the sensor pixel has an exposure level averaging both photodiodes (e.g., about 0.45). Alternatively, the control circuit device 108 may receive the highest exposure level from a plurality of subpixels. For example, a plurality of subpixels for a sensor pixel may have respective exposure levels ranging from about 0.04 to about 0.8, and the control circuitry device 108 determines the exposure level of the sensor pixel to be about 0.8.

The LC device panel 102 is disposed on an image sensor 106. For example, the LC device panel 102 may be adhered to the image sensor 106 (e.g., using an adhesive). For example, the LC device panel 102 may be directly bonded to the image sensor 106. In some embodiments, the LC device panel 102 may be hybrid bonded to the image sensor 106. In some aspects, the LC device panel 102 is configured as a dynamic light modulator. The LC device pixels may be aligned with the sensor pixel array 104. For example, an LC device pixel may be disposed directly over the sensor pixel 122, such that incident light 124 reaches the LC device pixel before the sensor pixel photodiode. The LC device pixel modulates the incident light 124 to manage the exposure of the sensor pixel. In this manner, the LC device pixel corresponds to the sensor pixel 122.

In some embodiments, an LC device pixel may correspond to a plurality of sensor pixels (e.g., disposed such that the LC device pixel manages exposure of the sensor pixels). Some of the sensor pixels may be adjacent to each other. For example, two or more sensor pixels corresponding to the LC device pixel may be disposed at adjacent positions in the sensor pixel array 104. Some of the sensor pixels may not be adjacent to each other. For example, a pair of first sensor pixels corresponding to the LC device pixel may have one or more second sensor pixels disposed therebetween. In some embodiments, the control circuit device 108 modifies a transparency level of a LC device pixel to modulate exposure of two or more sensor pixels of the image sensor.

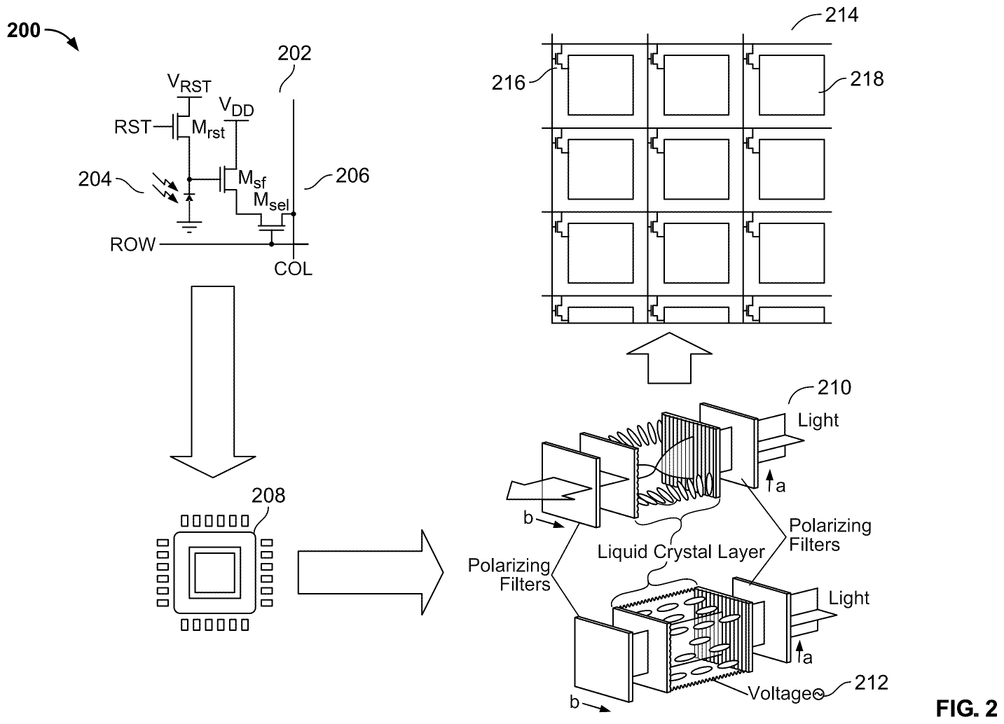

The control circuit device 108 may receive sensor data from the sensor pixel 122 and modify the transparency level of a corresponding LC device pixel to manage exposure of the sensor pixel 122 as described with respect to FIG. 2. The control circuit device 108 may modulate transparency of the LC device panel 102 at the LC device pixel level, for example, in response to sensor feedback from the image sensor 106 due to incident light. By adjusting voltage levels for the LC device pixel(s), the LC layer 115 allows a precisely controlled portion of the incident light 124 to reach the image sensor 106.

As an illustrative example, a LC device layer is disposed atop a CMOS sensor. The control circuit device 108 reads out the sensor output of the CMOS sensor. Based on the sensor output, the control circuit device 108 adjusts the transparency of the LC device layer pixels, for example, by setting their respective voltage levels. In this example, the CMOS sensor pixel values may be normalized such that the values are within a range of [0,1]. Due to physical conditions of the photosensitive material, a sensor pixel may clip values exceeding the range of [0,1] (e.g., to one or zero). A sensor pixel value at either extremum may not indicate the light intensity reaching the sensor pixel. The control circuit device 108 adjusts the transparency of a corresponding LC device pixel, for example, by reducing or increasing the transparency to control the exposure of the sensor pixel. In some embodiments, the adjusted pixel value range is renormalized after adjusting the LC device's transparency (e.g., to [0,1]).

The control circuit device 108 may progressively reduce (or increase) the transparency of an LC device pixel until the sensor pixel value is within the sensor pixel value range. In one example, a sensor pixel value may be one, indicating that the exposure meets or exceeds the pixel value range. The control circuit device 108 may set the transparency of an LC device pixel to 50% and determine the adjusted sensor pixel value. If the adjusted sensor pixel value is unchanged (e.g., one), the control circuit device 108 may reduce the transparency of the LC device pixel to 25% and so forth. The control circuit device 108 may increase the transparency of the LC device pixel to refine the adjusted sensor pixel value, for example, to be near to the extrema (e.g., about 0.999).

In some aspects, the sensor pixel value range is extended proportional to the transparency. For example, the control circuit device 108 reducing the transparency from 100% to 50% may extend the sensor pixel value range from [0,1] to [0,2]. In some embodiments, the LC device layer may be initialized to 100% transparency for determining the image sensor pixel value ranges (e.g., to calibrate the imaging device 100). In some embodiments, the LC device layer starts with a pre-determined transparency mask (e.g., a previously applied transparency mask retrieved from the device memory, a default configuration, etc.).

In some embodiments, an LC pixel comprises one or more polarizers and a transistor film in an active-matrix configuration. In some embodiments, the image sensor comprises back-illuminated CMOS sensor pixels. In some embodiments, the LC device pixels may have a different pixel size than pixels of the image sensor. For example, one or more LC device pixels have about a same or larger size than one or more pixels of the image sensor. For example, one or more pixels of the image sensor may have a first pixel size, and one or more LC device pixels may have a second pixel size between about the first pixel size to about twice the first pixel size (e.g., around 1.5 times the first pixel size). For example, the second pixel size may be larger than twice the first pixel size (e.g., multiplied by a factor such as about 2.2, 3.4, 20.4, 100.3, etc.). In an analogous example, one or more LC device pixels may have about a same or smaller size than pixels of the image sensor. In some embodiments, exposure of at least one sensor pixel having a first pixel size is modulated by two or more LC device pixels having a second pixel size about the same or less than the first pixel size.

FIG. 2 shows an illustrative flow diagram 200 for integrated exposure control of an imaging device (e.g., the imaging device 100), in accordance with some embodiments of this disclosure. The diagram 200 shows an image sensing circuit 202 receiving incident light at a photodiode 204 and outputting sensor data 206 to control circuitry 208. The control circuitry 208 analyzes the sensor data 206 and adjusts transparency of an example LC device pixel array 214, for example, through a voltage 212 applied to a liquid crystal component (e.g., the LC layer) of an LC device pixel 210. The control circuitry 208 may apply respective voltages for each LC device pixel (e.g., LC device pixel 218) using transistor switch 216. In some embodiments, the LC device pixels are disposed in individually controllable rows and columns. For example, the control circuitry 208 may apply the same voltage to the row of pixels including the LC device pixel 218. In some embodiments, the control circuitry 208 applies a different voltage to one or more pixels in the same row and/or column. As an example, the LC device pixel 210 may comprise a capacitor having a layer of insulating liquid crystal between transparent conductive layers (e.g., comprising ITO). It is noted that the LC device pixel array 214 is an illustrative pixel architecture and is intended to be non-limiting. Some example sensor layouts include active-pixel sensors, passive-pixel sensors, digital-pixel sensors, etc.)

As an illustrative example with a twisted-nematic-type LC device, incident light is filtered through a first polarizing filter (e.g., polarizer 110). An LC pixel may be configured such that the portion of the LC layer (e.g., layer 115) proximate to a first electrode (e.g., electrode 114) is aligned in a direction perpendicular to the portion of the LC layer proximate to a second electrode (e.g., electrode 116). The liquid crystal molecules of the LC layer may be arranged in a helical, or twisted, orientation without an electric field present (e.g., without an applied voltage). The orientation induces a rotation of the polarization of the incident light, managing how much of the light passes through a second polarizing filter (e.g., polarizer 120). The transparency level of the LC device pixel is related to how much rotation is induced, that is, how much light passes through the second polarizing filter. If the incident light passes through the second polarizing filter, the LC device pixel may be considered transparent or translucent. The transparency level may be measured based on the fraction of light through the second polarizing filter. As the applied voltage increases, the LC orientation induces less rotation. When the voltage meets or exceeds a threshold (e.g., based on the LC composition), the LC layer may have an untwisted orientation, which leaves the polarization of the incident light unrotated and perpendicular to the second polarizing filter. The second polarizing filter would block the incident light, and the pixel appears opaque. The transparency may be measured as zero.

The image sensing circuit 202 comprises a photodetector (e.g., photodiode 204), a floating diffusion, and a CMOS cell comprising a plurality of CMOS transistors (e.g., a 3T cell, a 4T cell, a 5T cell, etc.). The CMOS cell may comprise a transfer gate, reset gate, selection gate and source-follower readout transistor. The read-out transistor, M_{sf}, amplifies a pixel voltage to an observable range without removing accumulated charge. The select transistor, Mₛₑₗ, allows a single row of the pixel array to be read by the read-out electronics. A CMOS cell may have a saturation amount of accumulated charge, which is related to the exposure range of the sensor pixel. A photodetector may be saturated after exceeding a light intensity threshold, and sensor pixel values may be clipped as described with respect to FIG. 1. It is noted that the image sensing circuit 202 is intended to illustrative and non-limiting, and other suitable photodetecting circuitry may be implemented without departing from the teachings of the present disclosure.

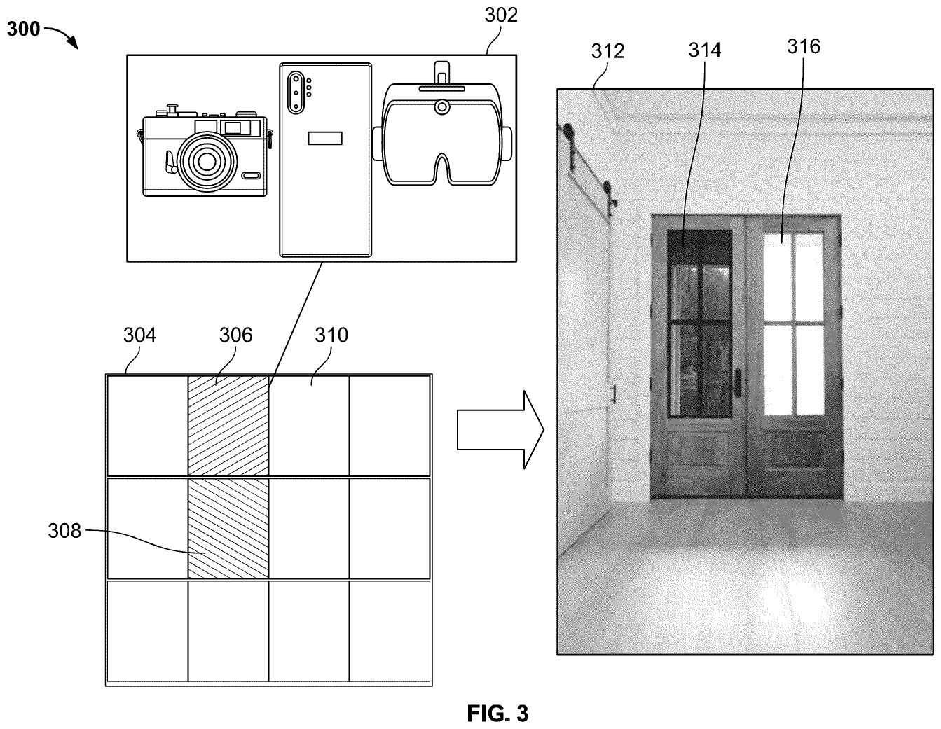

FIG. 3 shows an illustrative scenario 300 of HDR imaging using integrated exposure control, in accordance with some embodiments of this disclosure. Some example user devices 302 may incorporate an imaging device (e.g., imaging device 100) having a transparency mask 304. The transparency mask 304 may be applied to a light modulator (e.g., an LC device) having pixels 306, 308, 310 with controllable transparency levels (e.g., LC device pixels). Each pixel may have a different transparency. For example, pixel 306 may have a different transparency than pixel 308.

At the scenario 300, a user device 302 captures an image 312 using the imaging device. The image 312 shows a scene having disparate brightness levels (e.g., indoor and outdoor settings). Control circuitry of the imaging device adjusts the light modulation settings of the imaging device, defining the transparency mask 304. As an illustrative example, the transparencies of pixels 306, 308 are adjusted to values less than 100%, and the transparency of pixel 310 is set to 100%. Image sensor pixel(s) corresponding to the pixels 306, 308 may have exposure levels suitable for capturing details of an image region 314 (e.g., an outdoor setting). In comparison, image sensor pixel(s) corresponding to the pixel 310 may be overexposed. The image 312 may have an overly bright region 316 due to the overexposed image sensor pixel(s). In some embodiments, control circuitry of the imaging device may subsequently receive the exposure levels of these image sensor pixel(s) and update the transparency mask 304, for example, by adjusting the transparency of pixel 310 to a value less than 100%.

In some embodiments, the control circuitry may increase the transparencies of pixels 306, 308 corresponding to the image region 314 if the pixels for the image region 314 would not exceed an acceptable exposure range (e.g., not overexposed or within an exposure range of the corresponding image sensor pixel). For example, the image region 314 may have an exposure level that falls within the acceptable exposure range (e.g., not underexposed or overexposed). The control circuitry may compute an expected exposure level based on modified transparencies of the pixels 306, 308. The control circuitry may determine, based on sensor data from the corresponding image sensor pixel(s), that the expected exposure level is within the acceptable exposure range. In response to determining that the expected exposure level is within the acceptable exposure range, the control circuitry may modify the transparencies of the pixels 306, 308.

As an illustrative example, the control circuitry may determine that the current exposure level is within the acceptable exposure range but results in some loss of detail for the image region 314 (e.g., based on signal-to-noise ratio or another suitable metric). The control circuitry may tune the transparencies of the pixels 306, 308 to reduce the loss of detail for the image region 314. In this manner, the control circuitry manages exposure of the imaging device around the sensor pixel scale and improves the dynamic range of an image sensor by mitigating the loss of detail.

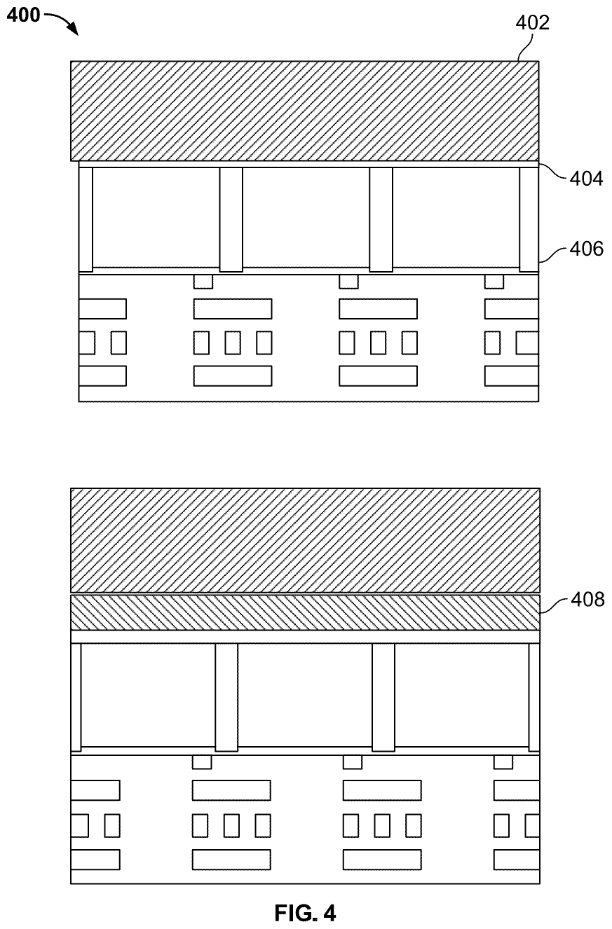

FIG. 4 shows illustrative structures 400 having a light modulator 402 attached to an image sensor 406, in accordance with some embodiments of this disclosure. The light modulator 402 may be attached to the image sensor 406 using one or more suitable techniques, for example, through direct bonds 404 or using an adhesive 408. The direct bonds 404 may include hybrid bonds. The direct bonds 404 may include direct dielectric bonds. The adhesive 408 may comprise a transparent adhesive layer. In some embodiments, the adhesive 408 has a thickness less than a thickness of the light modulator 402 and/or a thickness of the image sensor 406.

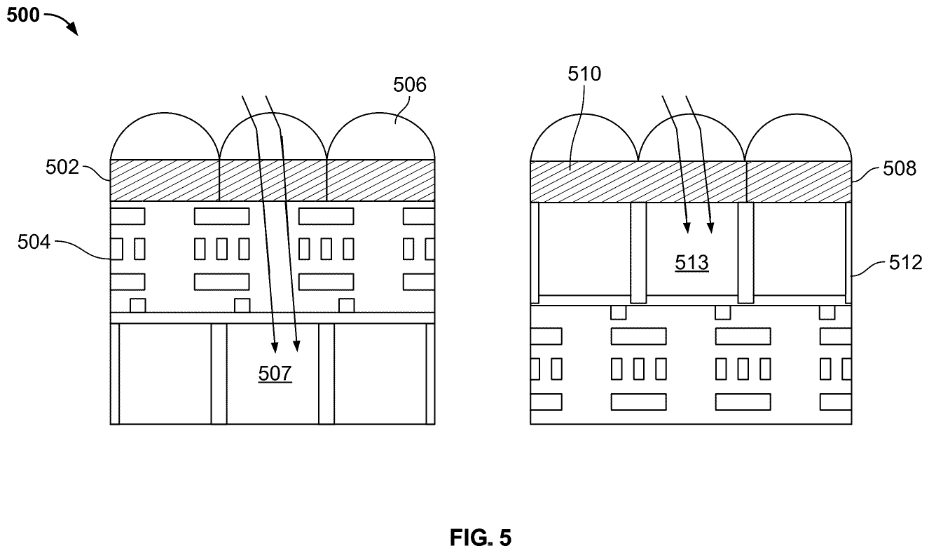

In some embodiments, the light modulator 402 is attached to a side of an image sensor 406 using a wafer-to-wafer process, a die-to-wafer process, or a die-to-die process. For example, the light modulator 402 may comprise one or more LC device dies (e.g., singulated dies) that are positioned over and/or aligned with corresponding sensor pixels of the image sensor 406 and attached to the side of the image sensor 406. For example, the light modulator 402 may have a substrate comprising LC device pixels that are positioned over and/or aligned with corresponding sensor pixels of the image sensor 406, where the substrate is attached the side of the image sensor 406. As an example, one or more image sensor dies may be attached to the light modulator 402. In some embodiments, one or more image sensor dies may be attached to one or more device dies of the light modulator 402 as described with respect to FIG. 5. For example, two or more image sensor dies may be attached to an LC device die.

FIG. 5 shows example bonded structures 500 of LC device dies 502, 508 attached to CMOS sensor dies 504, 512, in accordance with some embodiments of this disclosure. For the example structures 500, the LC device dies 502, 508 provide color filtering functions for the sensor dies 504, 512. For example, the LC device die 502 may comprise a color filter such as color filter 118, and the sensor die 504 does not include a color filter. Incident light may reach photodiodes (e.g., photodiodes 507, 513) of the sensor dies 504, 512 through the LC device dies 502, 508. An LC device die may comprise one or more LC pixels. For example, the LC device die 502 comprises three LC pixels. For example, the LC device die 508 may comprise first and second LC pixels, where the first LC pixel (e.g., LC pixel 510) has a greater pixel size than the second LC pixel. As an illustrative example, the LC pixel 510 may correspond to a plurality of pixels of the sensor die 512. In some embodiments, an LC pixel may modulate exposure for a plurality of sensor pixels. Two or more of the plurality of sensor pixels may be adjacent to each other.

The example structures 500 comprise one or more optical lenses 506. For example, the optical lenses 506 may be a micro-lens array. In some embodiments, the optical lenses 506 may comprise an optical lens system (e.g., compound lenses). Some example lens types include spherical, cylindrical, aspheric, Fresnel, lenticular, superlenses, diffractive elements, flexible, planar, etc. In some embodiments, the optical lenses 506 have varying sizes. For example with a subpixel configuration, a lens for a first photodiode may have greater dimensions than a lens for a second photodiode.

In some embodiments, an image sensor (e.g., a CMOS sensor) may be in a front-illuminated configuration (e.g., sensor die 504) or a back-illuminated configuration (e.g., sensor die 512). For example, the CMOS sensor die 504 may be in a back-illuminated configuration suitable for low-light scenes. In some embodiments, an image sensor may comprise a first plurality of pixels in a front-illuminated configuration and a second plurality of pixels in a back-illuminated configuration. Control circuitry of the imaging device (e.g., control circuit device 108) may detect the environmental conditions (e.g., low-light scenes) and determine a transparency mask based on sensor data from one or both of the first and second pluralities of pixels. The control circuitry may apply the transparency mask at the corresponding light modulator pixels. For example, if a camera is set to a low-light mode, the control circuitry of the imaging device may determine the transparency mask based on sensor data from the sensor pixels in a back-illuminated configuration.

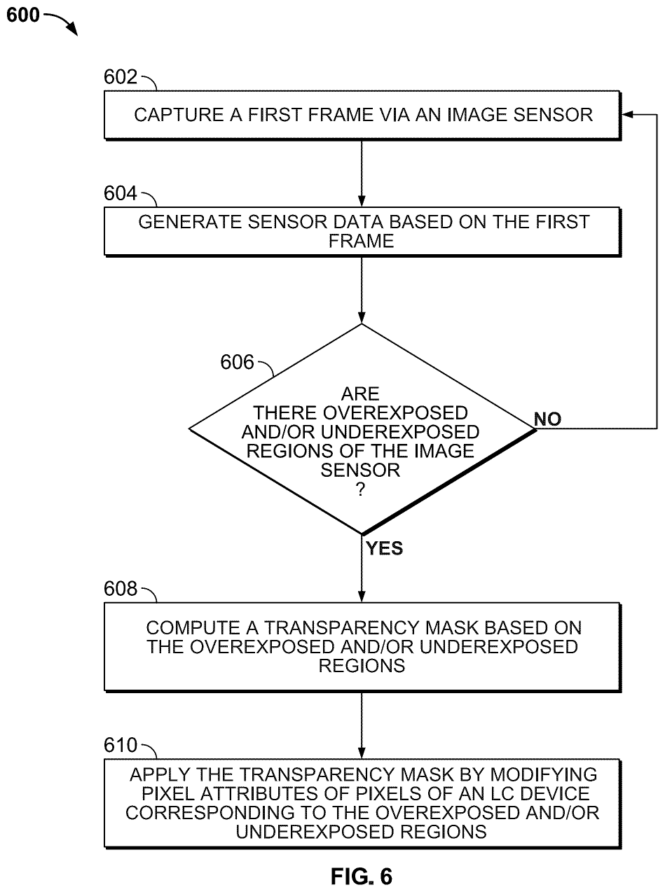

FIG. 6 is a flowchart of a detailed illustrative process 600 for integrated exposure control, in accordance with some embodiments of this disclosure. Process 600 may be executed by control circuitry (e.g., device 108, control circuitry 904) on a device (e.g., imaging device 100, system-on-chip (SoC) 901). It should be noted that the process 600, or any step thereof, could be performed on, or provided by, any of the devices described with respect to FIGS. 1-5, 9. Although the process 600 is illustrated and described as a sequence of steps, it is contemplated that various embodiments of the process may be performed in any order or combination and need not include all the described blocks.

At block 602, the control circuitry captures a first frame via an image sensor. At block 604, the control circuitry generates sensor data based on the first frame (e.g., through exposure analysis and/or machine vision techniques). In some embodiments, the control circuitry obtains the sensor data corresponding to the first frame from the image sensor. At block 606, the control circuitry identifies overexposed and/or underexposed regions based on the sensor data. If there are no overexposed or underexposed regions, the control circuitry may continue to block 602 for a subsequent frame. For example, if brightness levels of an image are within a dynamic range of the image sensor, the control circuitry may determine that the exposure levels are adequate. If overexposed and/or underexposed regions are identified, the control circuitry computes a transparency mask based on the overexposed and/or underexposed regions. For example, the control circuitry may identify a plurality of sensor pixels corresponding to these regions by determining which sensor pixels have an exposure level meeting or exceeding the exposure range. For example, the control circuitry may determine the plurality of sensor pixels corresponding to the overexposed and/or underexposed regions based on the sensor pixel positions. The control circuitry identifies LC device pixels corresponding to the plurality of sensor pixels and computes transparencies of the LC device pixels that adjusts the exposure levels of the image sensor pixels. At block 610, the control circuitry applies the transparency mask by modifying pixel attributes of the LC device pixels.

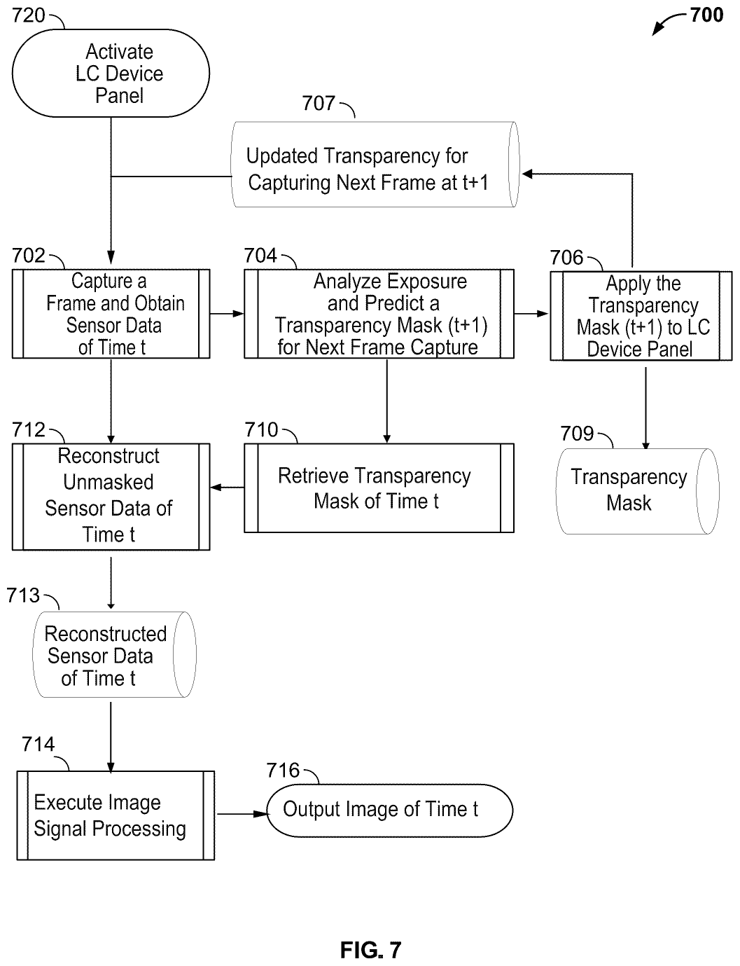

FIG. 7 is a flowchart of a detailed illustrative process 700 for image processing including integrated exposure control, in accordance with some embodiments of this disclosure. Process 700 may be executed by control circuitry (e.g., device 108, control circuitry 904) on a device (e.g., imaging device 100, SoC 901). It should be noted that the process 700, or any step thereof, could be performed on, or provided by, any of the devices described with respect to FIGS. 1-5, 9. Although the process 700 is illustrated and described as a sequence of steps, it is contemplated that various embodiments of the process may be performed in any order or combination and need not include all the described blocks. One or more of the described steps (e.g., blocks 704, 712) may be performed concurrently, in parallel, etc. with one or more other steps.

At block 720, an LC device panel may be activated with a starting transparency mask. Optionally, the LC device panel may be initialized as fully transparent, for example, to generate an image capture preview or generate a starting video frame. The process 700 includes illustrative timings between a first timepoint (labeled (t)) and a subsequent second timepoint (labeled (t+1)), where timings corresponding to the one or more parts are denoted by the timepoint label.

At block 702, control circuitry captures a frame at time t and obtains the sensor data corresponding to the frame captured of time t (also referred to as sensor data (t)). At block 704, the control circuitry analyzes the exposure based on the sensor data (t) and determines a predicted transparency mask (or mask 709) for capturing a frame of time t+1 (also referred to as predicted transparency mask (t+1)). At 706, the control circuitry applies the predicted transparency mask (t+1) to the LC device panel. In some embodiments, the control circuitry may provide pixel attribute data 707 to update the transparencies for capturing a frame at time t+1 (also referred to as frame (t+1)). In some embodiments, the control circuitry stores the mask 709 in memory (e.g., memory cache 909, a buffer, RAM, etc.) for reconstructing frame (t+1). In some embodiments, the control circuitry is configured to store in the memory one or more frames captured at the image sensor. The control circuitry may determine a transparency mask of time t corresponding to frame of time t (also referred to as transparency mask (t) and frame (t), respectively). For example, at block 710, the control circuitry retrieves the mask data (t) from the memory. At block 712, the control circuitry reconstructs sensor data (t) without the transparency mask (t) to generate reconstructed sensor data (t) (e.g., reconstructed sensor data 713). The sensor data without the transparency mask may be referred to as reconstructed sensor data, unmasked sensor data, native sensor data, and/or raw sensor data. At block 714, the control circuitry may execute an image signal processing (ISP) pipeline based on the unmasked sensor data to generate an image or other visual content (e.g., a video frame). Executing the ISP pipeline may comprise executing one or more ISP algorithms with the reconstructed sensor data. At block 716, the control circuitry outputs the image corresponding to the frame (t).

In some aspects, unmasked sensor data may be analogous to the sensor data corresponding to a frame captured when the LC device panel is at 100% transparency. The control circuitry may reconstruct the unmasked sensor data corresponding to frame (t) based on the sensor data (t) and the transparency mask (t). For example, the control circuitry may determine an expected exposure level of a sensor pixel based on a corresponding LC device pixel at 100% transparency. In some embodiments, the control circuitry may align timing of the transparency mask and the sensor data such that the sensor data and the transparency mask correspond to the frame (t). In some embodiments, the control circuitry reconstructs the unmasked sensor data before ISP pipeline.

As an illustrative example, for a frame (t) and a first sensor pixel, the control circuitry may determine an unmasked sensor pixel value based on sensor data (t) of the first sensor pixel and the transparency of the corresponding LC device pixel(s). For example, the control circuitry may divide the sensor pixel value by the transparency to compute the unmasked sensor pixel value. In some embodiments, the unmasked sensor pixel values may be normalized (e.g., to a range of [0,1]). In some embodiments, the control circuitry is configured to maintain high-precision computing. For example, the control circuitry may be configured for double-precision floating-point computing (e.g., 64-bit). Additionally, or alternatively, the control circuitry may be configured for mixed-precision computing by modifying the number of bits. For example, the control circuitry may compute using single-precision and/or store the unmasked pixel values using double-precision.

In some embodiments, the control circuitry provides the unmasked sensor data to an ISP module for image processing. For example, reconstructing the unmasked sensor data may be implemented separate from the ISP module at a processing unit (e.g., IPU, DSP, etc.). In some embodiments, the control circuitry receives the sensor data (t) and the transparency mask (t) through a communication path that bypasses an ISP module. In some embodiments, the control circuitry, or another component (e.g., system controller 920), may use time multiplexing such that the control circuitry receives sensor data (t) and transparency mask (t) through input/output paths of the ISP module. In some embodiments, the control circuitry may be part of the ISP module. The control circuitry may provide one or more instructions to an LC device panel and/or image sensor through the ISP module. The LC device panel and/or image sensor may provide data (e.g., sensor data, transparency data) corresponding to a frame (t) based on the one or more instructions.

In some embodiments, the control circuitry may manage exposure of sensor pixels by tuning the transparency of corresponding LC device pixel(s). For example, the control circuitry may perform the tuning until the sensor pixel values are within the exposure range. For example, the exposure of one or more sensor pixels may be within an exposure range, but a signal-to-noise ratio (SNR) may be improved for the one or more sensor pixels. In some embodiments, the control circuitry executes an optimization loop that tunes the sensor pixel values and corresponding LC device pixel transparency values until a target image quality or SNR is achieved. In some aspects, the tuning may increase precision of a sensor pixel value to maintain and/or improve image quality. The control circuitry may improve the SNR for each sensor pixel through the tuning by balancing exposure of the sensor pixels. In some embodiments, the control circuitry determines a stabilized transparency mask through tuning the transparencies of one or more LC device pixels. In some embodiments, the control circuitry determines a stabilized transparency mask without tuning. For example, the target SNR may be achieved after one iteration.

As an illustrative example, a CMOS sensor pixel may have a pixel value x, and a corresponding LC pixel transparency value may be k. If x is one, the sensor pixel may be saturated such that the exposure may be clipped to one. In an analogous manner, if x is zero, the LC pixel may be preventing sufficient light from reaching the sensor pixel such that the exposure may be zero. The control circuitry modifies the transparency value. For example, if k is less than one and/or x is a small value less than one, the control circuitry increases the transparency value to k′. The corresponding pixel value may be increased to x′ that is less than one. In some embodiments, the control circuitry adjusts the transparency value by multiplying the transparency value with a factor. The factor may be different between frames, pixels, etc. For example, a pixel value may be less than one-half, and a corresponding transparency value may be less than or equal to one-half. The control circuitry may double the corresponding transparency value, which doubles the pixel value to a value within the normalized exposure range. It is noted that other values may be used without departing from the teachings of the present disclosure.

A transparency mask may not correspond to the next frame in a dynamic scene that may have changed from time t to time t+1. In some embodiments, the control circuitry determines a transparency mask based on predicted changes between a frame (t) and a frame (t+1) (e.g., for a dynamic scene). For example, a static scene may have little change (e.g., objects remain unmoved and/or lighting remains relatively unchanged between frames). The image sensor may have the same exposure per pixel, so a transparency mask (t+1) based on frame (t), such as a stabilized transparency mask through tuning the transparencies, can be applied to a frame (t+1). For example, if frame (t) is about the same as frame (t+1) of a static scene, the transparency mask (t+1) corresponds to the exposure of the image sensor during capture of frame of time t+1. For a dynamic scene, the exposure per sensor pixel may change between frame (t) and frame (t+1). A transparency mask computed based on frame (t) may not account for the change in the dynamic scene. For example, a light source may change position, intensity, etc. in a dynamic scene. The sensor pixel exposure may be considered to have moved from a first position to a second position. A transparency mask computed based on frame (t) may not include the changes due to the moved light source. In some embodiments, the control circuitry may dilate the transparency values (e.g., using a morphological operator) for LC pixels proximate to an LC pixel corresponding to the sensor pixel at the first position. For example, a sensor pixel value may move from the first position to the second position, and the transparency value belongs to a first LC pixel corresponding to the first position. The control circuitry may apply the transparency value to a plurality of LC pixels proximate to the first LC pixel such that the transparency mask is dilated around the first position. The dilation may include an LC pixel that corresponds to the second position.

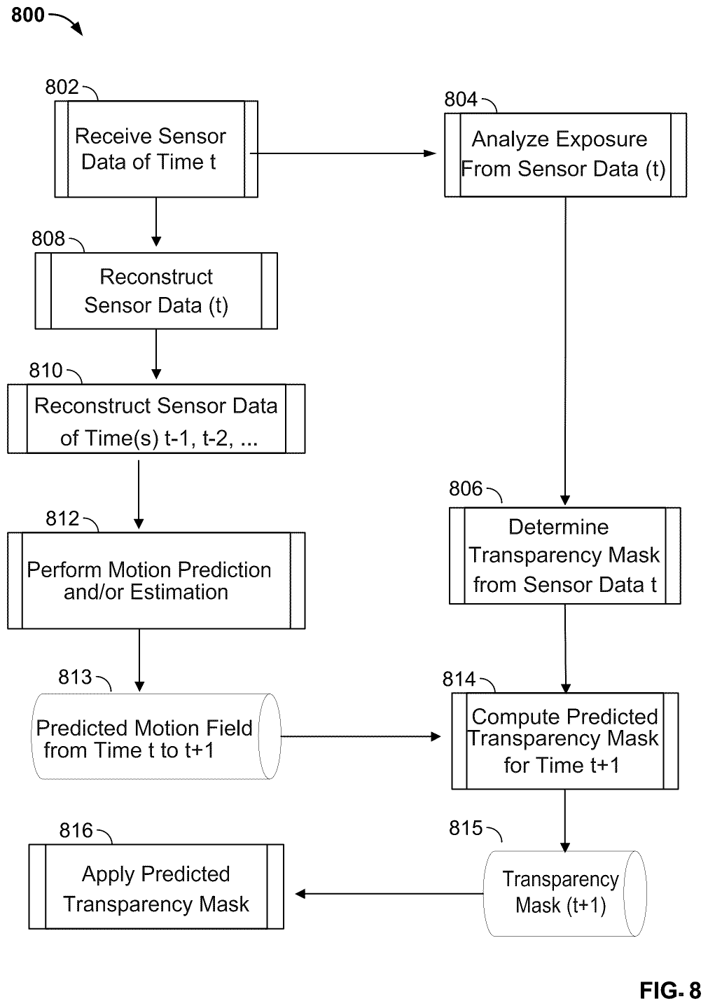

FIG. 8 is a flowchart of a detailed illustrative process 800 for image processing of dynamic scenes including integrated exposure control, in accordance with some embodiments of this disclosure. Process 800 may be executed by control circuitry (e.g., device 108, control circuitry 904) on a device (e.g., imaging device 100, SoC 901). It should be noted that the process 800, or any step thereof, could be performed on, or provided by, any of the devices described with respect to FIGS. 1-5, 9. Although the process 800 is illustrated and described as a sequence of steps, it is contemplated that various embodiments of the process may be performed in any order or combination and need not include all the described blocks. One or more of the described steps (e.g., blocks 804, 808) may be performed concurrently, in parallel, etc. with one or more other steps. The process 800 includes illustrative timings between a first timepoint (labeled (t)) and a subsequent second timepoint (labeled (t+1)), where timings corresponding to the one or more parts are denoted by the timepoint label.

At block 802, the control circuitry receives sensor data of time t (also referred to as sensor data (t)). At block 804, the control circuitry analyzes the exposure based on the sensor data (t). At block 806, the control circuitry determines a transparency mask of time t+1 (also referred to as transparency mask (t+1)) based on the sensor data (t). The transparency mask (t+1) corresponds to sensor data based on a frame captured at time t (also referred to as frame (t)). As mentioned in preceding paragraphs, the transparency mask (t+1), such as a stabilized transparency mask, may correspond to exposure of an image sensor during capture of a subsequent frame in a static scene. For example, the control circuitry may determine that sensor data of time t+1 (also referred to as sensor data (t+1)) includes about the same exposure values as sensor data (t). In this example, the transparency mask (t+1) may be applied to a frame (t+1) of the static scene. For a dynamic scene, the control circuitry determines the predicted motion to compensate for changes in the dynamic scene. At block 808, the control circuitry reconstructs unmasked sensor data of time t (also referred to as unmasked sensor data (t)) based on sensor data (t) and mask data corresponding to sensor data (t) (also referred to as mask data (t)). The control circuitry may retrieve mask data (t) from memory. At block 810, the control circuitry reconstructs unmasked sensor data corresponding to one or more previous frames based on related sensor data (e.g., sensor data corresponding to times t−1, t−2, . . . ) and transparency masks (e.g., mask data corresponding to sensor data of times t−1, t−2, . . . ). In some embodiments, the control circuitry retrieves the data corresponding to the one or more previous frames from memory. For example, the control circuitry may have stored the sensor data and/or mask data for the one or more previous frames.

At block 812, the control circuitry performs one or more motion prediction and/or estimation techniques, generating a predicted motion field 813 for a subsequent frame (e.g., indicative of the optical flow from time t to time t+1). In some aspects, the predicted motion field 813 may represent a mapping between image (or pixel) coordinates and a motion vector (e.g., a 2D projection of a point in a 3D scene). In some embodiments, the control circuitry may determine a predicted motion field (e.g., using motion prediction techniques such as optical flow techniques including phase correlation, block-based, derivative-based and variational methods, discrete optimization, etc.) that indicates the expected motion of the sensor pixel values. For example, the control circuitry may determine the predicted motion using a machine learning model (e.g., a deep learning neural network) such as a motion prediction model (e.g., video prediction, action prediction, trajectory prediction, etc.). For example, the control circuitry may determine the predicted motion based on one or more previous frames (e.g., frame t, t−1, t−2, etc.).

As an illustrative example, the control circuitry, using an optical flow technique, may track the motion of a plurality of sensor pixels based on sensor data of the previous frames and determine a direction and/or speed (e.g., stored as a flow vector) corresponding to exposures of the plurality of sensor pixels. The control circuitry may track the motion based on exposure levels of the plurality of pixels. For example, the control circuitry identifies a first sensor pixel having a first exposure level (e.g., 0.47) corresponding to a first frame (e.g., frame of time t−1). The control circuitry analyzes sensor data of a subsequent frame (e.g., frame of time t) to identify a second sensor pixel having an exposure level (e.g., 0.4711) that is about the same as the first exposure level. In some embodiments, the control circuitry may compare the exposure levels, for example, at high floating-point precision (e.g., 64-bit). The control circuitry may determine that the first sensor pixel corresponds to the second sensor pixel based on a difference of the exposure levels being about zero or within a narrow range of zero (e.g., a difference of about 0.01 or less). In some aspects, the control circuitry tracks a brightness of an image portion to determine the motion corresponding to exposures of the plurality of sensor pixels. The control circuitry may compute a predicted motion field by determining the direction and/or speed for each sensor pixel. In some embodiments, the control circuitry may identify a plurality of features based on the sensor data and use an optical flow technique based on the features, where the number of features is less than the number of sensor pixels. It is contemplated that optical flow techniques and their variants, machine learning models, and/or other motion prediction techniques, and combinations thereof may be used in the aforementioned example without departing from the teachings of the present disclosure.

At block 814, the control circuitry computes a predicted transparency mask 815 based on the predicted motion field 813 and the transparency mask (t+1) from block 806. In some embodiments, the control circuitry determines the predicted transparency mask 815 using a motion prediction model based on sensor data corresponding to one or more frames (e.g., frames of times (t, t−1, t−2, . . . ). The control circuitry may compute the predicted transparency mask 815 by modifying the transparency mask (t+1) from block 806. In some embodiments, the control circuitry may determine that the expected exposure value is related to an exposure value corresponding to sensor pixel(s) for a region of frame (t) (e.g., an image region depicting the object at time t). For example, the control circuitry may transfer one or more transparency values from a first LC device pixel to second LC device pixel(s) corresponding to the moved sensor pixel based on the predicted motion field 813. As an illustrative example, a sensor pixel value may move from the first position to the second position, and a transparency value belongs to a first LC pixel corresponding to the first position. The control circuitry may determine a predicted motion of the sensor pixel value towards the second position based on frame (t) and/or one or more previous frames (t−1), etc. The control circuitry may identify a second LC device pixel corresponding to a position based on the predicted motion (e.g., the second position). The control circuitry may shift the transparency value from the first LC device pixel to the second LC device pixel. In some aspects, the control circuitry pre-adjusts a transparency mask to address the expected changes between the frame (t) and the frame (t+1) as indicated by a predicted motion field (e.g., predicted motion field 813).

As an illustrative example, the predicted motion field may indicate that an object (e.g., with an illuminated surface) moves in a scene to a region of frame (t+1). The control circuitry may determine, based on the predicted motion field, an expected exposure value for sensor pixel(s) corresponding to the region of frame (t+1). Based on the expected exposure value, the control circuitry may modify pixel attributes of one or more LC device pixels corresponding to the sensor pixel(s). At block 816, the control circuitry applies the predicted transparency mask for capturing a subsequent frame (e.g., frame (t+1)). For example, the control circuitry may cause capture of the frame (t+1) using an image sensor modulated by a light modulation layer to which the predicted transparency mask 815 is applied. In some embodiments, the control circuitry may determine the predicted motion field 813 after a number of iterations using the motion prediction technique at block 812. The control circuitry may reduce the number of iterations to improve performance depending on the imaging application (e.g., in video capture devices, extended reality devices, etc.).

In some embodiments, the control circuitry executes one or more post-processing algorithms to identify one or more overexposed and/or underexposed sensor pixel values.

The control circuitry may access sensor data information corresponding to previous frames (e.g., frames of times t, t−1, t−2, etc.). For example, the control circuitry may identify, based on the predicted motion field, that a second sensor pixel is overexposed or underexposed if a light source moved outside of a region having modulated exposure due to the applied transparency mask. The control circuitry may estimate the pixel value of the second sensor pixel based on the sensor pixel values in the previous frames and update the transparency mask based on the estimated pixel value.

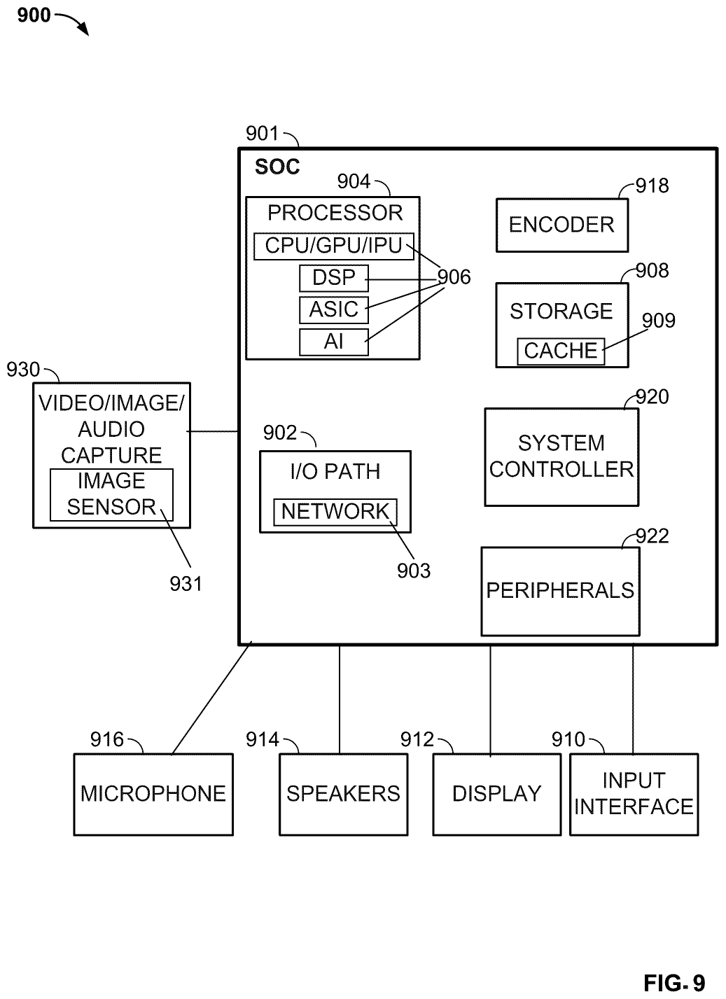

FIG. 9 shows a generalized embodiment of an imaging system 900, in accordance with some embodiments. The imaging system 900 may include a system-on-chip architecture, such as SoC 901. In some embodiments, the imaging system 900 may include a network-on-chip (NoC) architecture or other suitable IC design. The SoC 901 comprises I/O path 902, control circuitry 904, storage 908, encoder 918, and system controller 920. The SoC 901 may comprise one or more peripheral components 922. The SoC 901 may be coupled to and/or integrated with video/image/audio capture device 930. The capture device 930 may include an image sensor 931. The imaging system 900 comprises a light modulation device (e.g., LC device panel 102) coupled to the image sensor 931. In some embodiments, the SoC 901 is coupled to an interface 910, display 912, speakers 914, and/or microphone 916. One or more components of the imaging system 900 may correspond to one or more components of the imaging device 100. For example, the SoC 901 may correspond to the control circuit device 108. For example, the image sensor 106 may correspond to the image sensor 931.

As referred to herein, the term “content” should be understood to mean an electronically consumable asset accessed using any suitable electronic platform, such as broadcast television programming, pay-per-view programs, on-demand programs (as in video-on-demand (VOD) systems), Internet content (e.g., streaming content, downloadable content, Webcasts, etc.), video clips, audio, information about content, images, animations, documents, playlists, websites and webpages, articles, books, electronic books, blogs, chat sessions, social media, software applications, games, virtual reality media, augmented reality media, 3D modeling data (e.g., captured via 3D scanning, etc.), and/or any other media or multimedia and/or any combination thereof. Extended reality (XR) content refers to augmented reality (AR) content, virtual reality (VR) content, mixed reality (MR) content, hybrid content, and/or other digital content combined with or to mirror the physical world objects including interactions with such content.

The SoC 901 may receive and/or transmit content and data (e.g., imaging signals, device instructions, etc.) via input/output (I/O) path 902. The I/O path 902 may provide the data to control circuitry 904, which includes processing circuitry 906 and the storage 908. The control circuitry 904 may be used to send and receive commands, requests, and other suitable data using the I/O path 902. The I/O path 902 may connect the control circuitry 904 (and/or the processing circuitry 906) to one or more communications paths. I/O functions may be provided by one or more of these communications paths but are shown as a single path in FIG. 9 to avoid overcomplicating the drawing.

The control circuitry 904 may be based on any suitable processing circuitry such as the processing circuitry 906. As referred to herein, processing circuitry 906 should be understood to mean circuitry based on one or more microprocessors, coprocessors, microcontrollers, compute processing units (CPU), graphics processing units (GPU), image processing units (IPU), digital signal processors (DSP), programmable logic devices, field-programmable gate arrays (FPGAs), application-specific integrated circuits (ASICs), machine learning (ML) and/or AI accelerators (e.g., vision processing units (VPU)), etc., and may include a multi-core processor (e.g., dual-core, quad-core, hexa-core, or any suitable number of cores) or supercomputer. A VPU is a species of AI accelerator configured for accelerating machine vision functions. VPUs may be configured for various ML model architectures such as convolutional neural networks (CNN) and feature transforms (e.g., scale-invariant feature transform). In some embodiments, processing circuitry 906 may include direct paths for sensor data from capture devices that bypass external buffers to reach the VPUs. In some embodiments, the processing circuitry 906 may be distributed across multiple separate processors or processing units, for example, multiple of the same type of processing units (e.g., two Intel Core i7 processors) or multiple different processors (e.g., an Intel Core i5processor and an Intel Core i7 processor).

In client/server-based embodiments, the control circuitry 904 may include communications circuitry suitable for communicating with one or more servers that may at least implement one or more of the described functionalities (e.g., managing image sensor exposure at the pixel and/or subpixel scale). The instructions for carrying out the above-discussed functionalities may be stored on the one or more servers. Communications circuitry may be based on various industry standards including USB, FireWire, Ethernet, USART, SPI, HDMI, I²C, CSI, etc. Wireless networking protocols such as Wi-Fi, Bluetooth, 6LoWPAN and near-field communication may be supported. Communications circuitry may include a cable modem, an integrated service digital network (ISDN) modem, a digital subscriber line (DSL) modem, a telephone modem, an Ethernet card, or a wireless networking circuitry for communications with other equipment, or any other suitable communications circuitry. Such communications may involve the Internet or any other suitable communications networks or paths. In addition, communications circuitry may include circuitry that enables peer-to-peer communication between a plurality of devices, or communication of devices in locations remote from each other.

Memory may be an electronic storage device provided as the storage 908 that is part of the control circuitry 904. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVRs, sometimes called a personal video recorders, or PVRs), solid-state devices, quantum storage devices, gaming consoles, gaming media, or any other suitable fixed or removable storage devices, and/or any combination of the same. The storage 908 may be used to store various types of content and data described herein. Nonvolatile memory may also be used (e.g., to launch a boot-up routine and other instructions). In some embodiments, cloud-based storage may be used to supplement the storage 908 or instead of the storage 908.

The control circuitry 904 may include encoding circuitry (e.g., encoder 918), audio generating circuitry, and tuning circuitry, such as one or more analog tuners, audio generation circuitry, filters or any other suitable tuning or audio circuits or combinations of such circuits. The control circuitry 904 may also include scaler circuitry for upconverting and down converting content into any output format of the imaging system 900. The control circuitry 904 may also include digital-to-analog converter circuitry and analog-to-digital converter circuitry for converting between digital and analog signals. The tuning and encoding circuitry may be used by the imaging system 900 to receive and to display, to play, or to record content. The circuitry described herein, including, for example, the tuning, audio generating, encoding, decoding, encrypting, decrypting, scaler, and analog/digital circuitry, may be implemented using software running on one or more general purpose or specialized processors (e.g., processing circuitry 906). If the storage 908 is provided as a separate device from the imaging system 900, the tuning and/or encoding circuitry (including multiple tuners) may be associated with the storage 908.

The system controller 920 may generate clock signals, manage execution and timing of one or more functions of the SoC 901 and/or provide time context for one or more signal processing functions. The system controller 920 may include direct memory access, various timing sources and components thereof such as crystal oscillators (e.g., piezo-electric oscillators), phase-locked loops, frequency dividers, clock multipliers, amplifiers, etc. The peripheral components 922 of the SoC 901 may include counter-timers, real-time timers, power-on reset generators, voltage regulators, and/or power management circuits.

The imaging system 900 may optionally include or be coupled to an interface 910. The interface 910 may be any suitable input interface, such as a remote control, mouse, trackball, keypad, keyboard, touchscreen, touchpad, stylus input, joystick, or other input interfaces. A display 912 may be provided as a stand-alone device or integrated with other elements of the imaging system 900. For example, the display 912 may be a touchscreen or touch-sensitive display. The interface 910 may be integrated with or combined with a microphone 916. When the interface 910 is configured with a screen, such a screen may be one or more of a monitor, a television, a liquid crystal display (LCD) for a mobile device, active-matrix display, cathode ray tube display, light-emitting diode display, organic light-emitting diode display, quantum dot display, or any other suitable equipment for displaying visual images. In some embodiments, the interface 910 may be HDTV-capable. In some embodiments, the display 912 may be a 3D display. The speaker (or speakers) 914 may be provided as integrated with other elements of imaging system 900 or may be a stand-alone unit. The control circuitry 904 may receive vocal instructions, such as voice commands, through the microphone 916. The microphone 916 may be any microphone (or microphones) capable of detecting human speech. The microphone 916 may be connected to the processing circuitry 906 to transmit detected voice commands and other speech thereto for processing. In some embodiments, the peripheral components 922 may include components for supporting functionalities of the interface 910, display 912, speakers 914, microphone 916.

The capture device 930 may be any suitable device for digital image acquisition (e.g., a digital camera). The video/image capture device 930 includes image sensor 931. The video/image capture device 930 may include a light modulation layer such as the LC device panel 102. The image sensor 931 may be configured for capturing and digitizing signals in the optical spectrum (e.g., visible light, UV, IR, etc.). The image sensor 931 may include charge-coupled devices, active-pixel sensors (e.g., CMOS sensor), and/or combinations thereof (e.g., hybrid CCD/CMOS, a CCD-like architecture using CMOS technology). In some embodiments, the image sensor 931 may include color-separating components such as color filter arrays (e.g., Bayer filter), layered pixel sensors, dichroic prisms, etc. In some embodiments, the image sensor 931 does not include a color-separating component.

Any of the processes 600-800 may be executed by control circuitry (e.g., device 108, control circuitry 904) on a device (e.g., imaging device 100, SoC 901). In some embodiments, the control circuitry may be part of a remote server coupled to the device by way of a communications network or distributed over a combination of both. In some embodiments, instructions for executing process 900 may be encoded onto a non-transitory storage medium (e.g., the storage 908) as a set of instructions to be decoded and executed by processing circuitry (e.g., the processing circuitry 906). Processing circuitry may, in turn, provide instructions to other sub-circuits contained within control circuitry 904, such as the digital signal processing circuitry, and the like. It should be noted that the processes 600-800, or any step thereof, could be performed on, or provided by, any of the devices described with respect to FIGS. 1-5, 9. Although the processes 600-800 are illustrated and described as a sequence of steps, it is contemplated that various embodiments of processes may be performed in any order or combination and need not include all the described blocks.

The processes discussed herein are intended to be illustrative and not limiting. One skilled in the art would appreciate that the steps of the processes discussed herein may be omitted, modified, combined and/or rearranged, and any additional steps may be performed without departing from the scope of the present disclosure. More generally, the above disclosure is meant to be illustrative and not limiting. Only the claims that follow are meant to set bounds as to what the present disclosure includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. An imaging device comprising:
an image sensor;
a light modulation layer coupled to the image sensor, wherein the light modulation layer comprises a plurality of liquid-crystal (LC) device pixels disposed over the image sensor; and
control circuitry coupled to the image sensor and the light modulation layer, wherein the control circuitry is configured to apply a transparency mask to the light modulation layer by modifying, based on at least one frame captured at the image sensor, pixel attributes of the plurality of LC device pixels for modulating exposure of the image sensor.

2.-16. (canceled)

17. The imaging device of claim 1, further comprising a memory cache, and wherein the control circuitry is configured to:
store, in the memory cache, sensor data corresponding to one or more frames captured at the image sensor;
determine, using a motion prediction model based on the sensor data corresponding to the one or more stored frames, a predicted transparency mask; and
apply the predicted transparency mask to the light modulation layer for capturing a subsequent frame.

18. The imaging device of claim 1, further comprising a memory cache, and wherein the control circuitry is configured to:
store, in the memory cache, sensor data corresponding to one or more frames captured at the image sensor;
determine, using a motion prediction model based on the sensor data corresponding to the one or more stored frames, a predicted transparency mask; and
reconstruct sensor data without a transparency mask based on the sensor data corresponding to the one or more stored frames, wherein the predicted transparency mask is determined based on the sensor data without the transparency mask.

19. The imaging device of claim 17, wherein the control circuitry is further configured to apply the predicted transparency mask to the light modulation layer for capturing the subsequent frame by:
determining, using the motion prediction model, an expected exposure value for one or more sensor pixels corresponding to a region of the subsequent frame; and
modifying, based on the expected exposure value, a pixel attribute of one or more LC device pixels corresponding to the one or more sensor pixels.

20.-22. (canceled)

23. The imaging device of claim 1, wherein the image sensor is coupled to the light modulation layer through one of direct dielectric bonds or hybrid bonds.

24.-30. (canceled)

31. A method for modulating exposure of an imaging device, wherein the imaging device comprises an image sensor, a light modulation layer coupled to the image sensor and comprising a plurality of liquid-crystal (LC) device pixels, and control circuitry coupled to the image sensor and the light modulation layer, the method comprising:
capturing sensor data of a first frame;
identifying, based on the sensor data, one or more of an overexposed region or an underexposed region at the image sensor;
in response to identifying the one or more overexposed region or underexposed region:
computing a transparency mask based on the one or more overexposed region or underexposed region; and
applying, via the control circuitry, the transparency mask to the light modulation layer by modifying pixel attributes of the plurality of LC device pixels disposed over the one or more overexposed region or underexposed region.

32. The method of claim 31, wherein modifying the pixel attributes of the plurality of LC device pixels over the one or more overexposed region or underexposed region comprises:
modifying a transparency level of a LC device pixel to modulate exposure of one or more sensor pixels of the image sensor.

33.-44. (canceled)

45. The method of claim 31, further comprising, subsequent to applying the transparency mask:
capturing sensor data of a second frame;
reconstructing unmasked sensor data corresponding to the second frame based on the sensor data of the second frame and the transparency mask; and
executing one or more image signal processing algorithms with the reconstructed sensor data.

46. An imaging device comprising:
a CMOS sensor comprising a plurality of sensor pixels;
a liquid-crystal (LC) pixel array directly bonded to the CMOS sensor, wherein the LC pixel array comprises a plurality of LC pixels; and
wherein the LC pixel array modulates exposure of at least one sensor pixel of the CMOS sensor using one or more LC pixels of the plurality of LC pixels.

47.-53. (canceled)

54. The imaging device of claim 46, further comprising a memory cache, and wherein the LC pixel array is configured to store, in the memory cache, sensor data corresponding to one or more frames captured at the CMOS sensor.

55. The imaging device of claim 54, wherein the LC pixel array is further configured to determine, using a motion prediction model based on the sensor data corresponding to the one or more stored frames, a predicted transparency mask.

56.-75 (canceled)

76. The imaging device of claim 1, wherein:
an LC device pixel of the plurality of LC device pixels corresponds to two or more sensor pixels of the image sensor; and
the LC device pixel is configured to modulate exposure for the two or more corresponding sensor pixels.

77. The imaging device of claim 76, wherein:
the two or more sensor pixels are adjacent to each other;
the two or more sensor pixels of the image sensor have respective exposure levels;
and wherein the control circuitry is configured to modify pixel attributes of the LC device pixel corresponding to the two or more sensor pixels based on a highest exposure level of the respective exposure levels.

78. The imaging device of claim 1, wherein:
one or more LC device pixels of the plurality of LC device pixels has a different pixel size than one or more sensor pixels of the image sensor;
at least one sensor pixel of the one or more sensor pixels has a first pixel size;
the LC device pixel has a second pixel size that is about the same or greater than the first pixel size; and
the LC device pixel having the second pixel size modulates exposure of the at least one sensor pixel having the first pixel size.

79. The imaging device of claim 1, further comprising:
a memory cache; and
wherein the control circuitry is configured to:
store, in the memory cache, sensor data corresponding to one or more frames captured at the image sensor; and
determine, using a motion prediction model based on the sensor data corresponding to the one or more stored frames, a predicted transparency mask.

80. The method of claim 32, wherein:
the LC device pixel corresponds to two or more sensor pixels of the image sensor;
modifying the transparency level of the LC device pixel modulates exposure of the two or more sensor pixels; and
the two or more sensor pixels are adjacent to each other.

81. The method of claim 31, further comprising:
storing, in a memory cache, one or more frames captured at the image sensor; and
determining, using a motion prediction model based on the one or more stored frames, a predicted transparency mask.

82. The method of claim 31, wherein:
modifying the pixel attributes of the plurality of LC device pixels comprises modifying a transparency level of an LC device pixel; and
modifying the transparency level of the LC device pixel comprises adjusting a voltage applied to a liquid crystal component of the LC device pixel.

83. The imaging device of claim 46, wherein:
an LC pixel of the plurality of LC pixels corresponds to two or more sensor pixels of the CMOS sensor;
the two or more sensor pixels are adjacent to each other;
the two or more sensor pixels of the CMOS sensor have respective exposure levels; and
the LC pixel array is configured to modify pixel attributes of the LC pixel corresponding to the two or more sensor pixels based on a highest exposure level of the respective exposure levels.

84. The imaging device of claim 46, wherein:
the CMOS sensor is directly bonded to the LC pixel array through direct dielectric bonds or hybrid bonds formed therebetween.
